(19) United States
(12) Patent Application Publication
(10) Pub. No.: US 2005/0055187 A1
(43) Pub. Date: Mar. 10, 2005

(54) Method and system for interactive molecular docking and feedback

(76) Inventors: Brian Woody Sherman, Belchertown, MA (US); David F. Green, Wintrop, MA (US); Karl H. Ruping, Cambridge, MA (US)

Correspondence Address: Karl Ruping;MolySym, Inc., 411 Massachusetts Ave., Cambridge, MA, 02139, US

(21) Appl. No.: 10/866,017

(22) Filed: Jun. 10, 2004

Related U.S. Application Data
(60) Provisional application No. 60/477,283, filed on Jun. 10, 2003.

(51) Int. Cl. G06G 7/48; G06G 7/58

(52) U.S. Cl. 703/11; 703/12

(57) ABSTRACT

The modeling of two or more related systems is enhanced by combining physical and virtual modeling techniques to create an interactive modeling system. In the presence of one model, the manipulation of a second model has an impact on the characteristics of both models. User manipulation of a virtual model on a simulation software system changes the characteristics of a physical model through a feedback system, which may be in the form of a haptic arm connected to the physical model. The invention also represents the docking of two models, such as the docking of two molecular systems, and to have the results of this docking represented in the physical and virtual models.

### RELATED APPLICATIONS

This application claims benefit of U.S. Provisional Patent Application No. 60/477,283, filed by the same inventors on Jun. 10, 2003.

### FIELD OF INVENTION

The present invention relates in general to the fields of molecular modeling, simulation, and docking; and in particular to a system for interfacing a physical molecular model with one or more additional models (either physical or virtual), giving the capability of determining the relative spatial positioning of such models and the capability of providing feedback to such models.

### BACKGROUND

Physical molecular models currently exist in the form of simple chemical structure kits. These products allow a user to construct a physical atomistic model of a molecular system, such as a chemical compound, and observe how the structure of the model changes with manual physical manipulation. These systems are static, however, and are not interactive with other physical or virtual molecular models. The physical manipulations by the user have no constraints related to the actual molecule or molecular system of interest except for those imposed by the materials from which they are built. For example, in existing physical models a dihedral angle can be rotated freely with a uniform friction throughout the 360 degrees of rotation, even though in reality there is an energetic profile associated with each molecule and its current conformational state that makes some motions easier and other motions more difficult. No information associated with energetic stability or other molecular properties for a given geometric configuration are considered with these physical models because they do not have any computational device monitoring the state of the system. In essence, there exists no method to transmit data (such as the relative 3-dimensional locations and orientation of the atoms in one or more molecules, among multiple physical molecular models or between a physical model and a virtual model) between a physical molecular model and a computational device.

Computer software systems, for the construction and manipulation of virtual molecular models currently exist. Virtual software tools allow a user to create a virtual model, e.g., a molecule on a computer, to visualize the atomic structure and to simulate the characteristics of the molecular system. Some such software tools are capable of representing the molecular structure, analyzing the molecular energetics, and simulating changes within the molecule or interactions with other molecules. Some software tools incorporate quantum mechanical effects, either by semi-empirical methods or using actual ab initio methods. Examples of such commercially available software tools include Insight II, available from Accelrys (www.accelrys.com), and Visual Molecular Dynamics (University of Chicago). These tools allow a user to construct atomistic computer models of molecules, such as chemical compounds, and to manipulate the structure of these models. These virtual models can also be used in detailed computational analyses and simulations that enable the calculation of various properties of the system. Using such software systems, the interaction of two or more virtual molecules may be studied in detail, including computation of extensive energetic properties relating to the interactions and forces between such molecules.

While detailed in the scope of properties accessible through virtual modeling methods, the interface for using such software systems are typically cumbersome and non-intuitive. The user's visualization, manipulation and characterization of such molecular systems is also in the virtual, usually two-dimensional, space. Manual manipulation of a given molecular system is limited to the existing input devices that include a computer mouse, keyboard, and similar input devices that were not specially designed for the manipulation of molecular systems. Furthermore, virtual models suffer from the lack of physical feedback, which people are more accustomed to understand and intuitively interact with relative to visual cues on a computer display.

Molecular docking is generally defined as the relative positioning of two or more interacting bodies. Such a positioning can be done by means of complex algorithms to match physical properties of the multiple bodies or by a simple procedure such as visual analysis. Accurate and intuitive docking, with easy and accessible information of the docking process, is an important process in the development of pharmaceuticals and novel materials as well as in understanding the properties of existing systems. In the prior art, docking methods have been modeled with computational software systems, with only a small amount of input from the user in certain cases to manipulate basic characteristics such as distance and orientation. User input has been limited primarily due to the lack of a useful, intuitive interface for human input to the docking problem.

In the prior art computer input devices such as the keyboard and mouse only allow the manipulation of a small number of degrees of freedom at one time. For example, with a mouse only one degree of freedom can be sampled at a time. A virtual model may be rotated and translated independently as a rigid body in three dimensions with a mouse, but the simultaneous sampling of these rigid body motions or the incorporation of multiple internal degrees of freedom of the model for the study of molecular systems is not possible due to the limited input from a traditional mouse and keyboard. There currently exists no device for controlling all degrees of molecular freedom, including internal dihedral rotations, angle bending, and bond vibrations, as well as relative translational and rotational orientation.

A new tool is a hybrid modeling system where a physical model communicates with computer-based visualization and simulation software tools, which develop and maintain a virtual model analog of that physical model. This new tool is described by the same inventors in U.S. patent application Ser. No. 10/750.521, filed on Dec. 31, 2003, entitled Apparatus and Method for Integrating a Physical Molecular Model with a Computer-based Visualization and Simulation Model, which application is hereby incorporated by reference. However, this hybrid modeling system does not allow for spatial modeling between the molecules of interest, which is critical in molecular docking. Nor does it allow for haptic feedback to the physical model due to the presence of a second model, either physical or virtual.

Actual real world molecular docking involves significantly more degrees of freedom than rigid body motions. In particular, two interacting molecules are generally flexible, and may adopt different conformations based on their relative orientation. For optimal user interaction in molecular docking applications, an input device capable of simultaneously varying positional, orientational, and internal degrees of freedom of the interacting molecules is required. Such a device is one implementation of this invention.

Haptic feedback systems for motion in up to six degrees of freedom (three translational and three rotational) for a particular rigid body currently exist (to be referred to as external haptic feedback systems). These systems are used to interface with three-dimensional simulation software in the fields of engineering, medicine, and design. To our knowledge, there have been only limited implementations of the use of external haptic feedback systems for the purpose of molecular modeling. In particular, there have not been any uses of a haptic feedback system coupled with a molecular input device to be used in molecular modeling, molecular simulation and molecular visualization.

Haptic feedback systems for internal degrees if freedom for a body with internal degrees of freedom currently exist (to be referred to as internal haptic feedback systems). These systems are used in the field of robotics. However, internal haptic feedback systems have not been implemented for the purpose of molecular modeling or molecular interaction. In particular, there have not been any implementations of a molecular model that contains elements within the model capable of providing feedback to the model based on properties of the system.

The use of an external haptic feedback system in conjunction with an internal haptic feedback system has not been implemented in the field of molecular modeling. In particular, there have not been any implementations of a haptic feedback system to model molecular interactions within a single molecule or between multiple molecules. Potential applications of such a system include, but are not limited to, feedback based on changes in internal energy of a system during a manipulation, feedback based on interactions between multiple molecules in a docking calculation, and feedback to the model based on a change in the state of the system as may be observed after an energy minimization.

In the prior art, permutations of a molecular structure and its reaction with a second molecular structure can be simulated in a software system. However, the user has limited control over these molecular movements in the virtual model and there is no physical impact on the user studying such docking or interactions resulting from the changing properties of the system. Further, for the interaction with the virtual model itself, the user can only control a small number of degrees of freedom at a time with standard input methods, such as the mouse and keyboard.

The manipulation of a molecular system, such as chemical structures, through a physical model is much more intuitive, and coupled with haptic feedback in internal degrees of freedom as well as in gross rotational and translations degrees of freedom makes a significant leap in interactive molecular modeling. However, no system has incorporated a haptic feedback system with an interactive physical molecular model in which that model being in communication with a simulation software system determines and controls the characteristics of the haptic feedback system. Such a device is one implementation of this invention.

### SUMMARY OF THE INVENTION

The present invention seeks to overcome the limitations of physical and virtual models described above by enabling an interactive modeling system between two or more models. Aspects of the invention include two physical models that communicate with computer-based visualization and simulation software tools, and a physical model that interacts with a virtual model.

The present invention concerns the interaction between two or more models, one or more of those models being a physical model of a structure or system that is interfaces with a software system on a computation device. A computational device may be embedded in a physical model itself, or an independent device such as a computer workstation. A model may be of an architectural structure, a biological system, or a manufacturing facility.

A structure or system of interest may be a molecule, a set of molecules, a particular area of a molecule or sets of molecules, or an individual atomic element. In one embodiment of the invention, a molecular system of interest is represented by a physical model which interacts with a second molecular system of interest represented by a virtual model generated in a software system on a computational device. In a further embodiment, there may be multiple physical models interacting with each other, or multiple virtual models interacting with one or more physical models.

Another aspect of the invention features a spatial positioning system. In one embodiment a detection unit external to the physical model detects the location of a physical model, and the spatial positioning system determines the relative spatial positioning between models.

In a further embodiment, a physical model contains one or more positioning units, such as sensors, that are capable of determining the position and/or orientation of itself or a neighboring physical model. Consistent with the definition of molecular model above, this positioning unit may sense a portion of the molecular system of interest, such as an active site in a protein or an individual atomic unit. Such physical model may contain actuators, in direct or indirect communication with such positioning units, to control the physical characteristics of the molecular model based on the positioning units, the positioning system, or a feedback system as explained below.

In one embodiment, a positioning system communicating with or sensing one or more positioning units determines, or is informed of, the relative position and orientation of the one or more physical molecular models. A communications interface to a simulation software system reads from the positioning system the state of a physical model and generates a virtual model that may capture the features of the physical model. The software simulation system may also generate a virtual model with no physical counterpart. Other data may include user input, environmental conditions such as temperature, or other characteristics that influence the molecular model.

A further feature is a means for providing feedback, which may include but is not limited to force-feedback, to a physical model from the simulation software system, a spatial positioning system, or from a neighboring physical model. Such feedback may be provided with or without a spatial positioning system. Throughout this document the term feedback will refer to any feedback to the physical or virtual model, and the term model or molecular model will refer to any grouping of molecular systems or subset of a molecular system, such as an atomic unit.

The invention allows for the physical representation of the molecular docking of a sample molecular system, or an individual atomic unit, into a second molecular system, such as an idealized receptor. The variation of multiple degrees of freedom, such as translational, rotational, and internal, are required to generate the optimal bound structure. Throughout this document the term atomic unit shall mean an element of the system of interest, such as an atomic unit or a set of atomic units in a molecular system.

A docking system incorporates the characteristics of a physical model and other models, computational characteristics from a software simulation system, and the relative positioning of molecular models. In some implementations of the invention, a haptic system allows for feedback of changes in the above characteristics.

The modeling system can include a software program running on the computational unit and in communication with a software program running on the computer system of the virtual model. The software program of the computer system can include a graphic display visualization unit, and the visualization unit can present to a user a graphic display representing at least a portion of the physical model, at least a portion of the virtual model, or at least portions of both the physical and virtual models. The visualization unit can display structure information, energetic information, and physical properties, e.g., from the physical or virtual model of the hybrid model. Embodiments include a communications system that provides information from the computer system of the virtual model to the computational unit of the physical model.

One embodiment of the invention is as a method for realizing an interactive molecular docking system. The first step begins with the manipulation of a physical molecular model next to a second physical model. The models transmit their configurations, or a spatial position system detects their configurations, to a computational device having a simulation software system. This may be the internal physical manipulation of a physical model and or the change in space or position of a physical model. Throughout this document the term location and position will refer to the location or position of the molecule or the internal elements of the molecule.

The simulation software system constructs virtual models of the physical models. In some applications there may be a virtual model on the simulation software system without a physical model analog, which can also influence the interactivity of one or more physical models. The simulation software system computes the various properties of the molecular system, such as the conformational energetics, the energetics of interaction of the two models, and the dynamic behavior of a system of models undergoing some transformation. This and other information of the models and the simulation system establishes the simulation environment. The simulation environment or elements of the simulation environment are sent as feedback to the physical model. This feedback may be in the form of a haptic feedback system for a particular physical model or models. The feedback system enables the physical model to be modified such that it conforms to all or part of the simulation environment.

### BRIEF DESCRIPTION OF THE DRAWINGS

The foregoing discussion will be understood more readily from the following detailed description of the invention, when taken in conjunction with the accompanying drawings, in which:

FIG. 1 is an exemplary diagram of an interactive physical model and virtual model system for representing two molecular systems;

FIGS. 2A and 2B are exemplary diagrams illustrating the component parts of a molecular model comprising an atom and a bond;

FIGS. 3 is an exemplary diagrams of a means of establishing the relative spatial position of two models;

FIGS. 4 is an exemplary diagram of a spatial positioning system and a physical model with multiple positioning units across multiple atomic units;

FIG. 5 is an exemplary diagram of a spatial positioning system and a physical model with positioning units in a subset of atomic units;

FIG. 6(a)-(b) are exemplary diagrams of three possible means of determining relative position between multiple models;

FIG. 7 is an exemplary diagram of two physical models interacting with each other;

FIG. 8 is an exemplary diagram of the docking of a molecule and a receptor;

FIG. 9 illustrates various possible docking orientations of two systems;

FIG. 10 is an exemplary diagram of a model connected to a haptic feedback system;

FIG. 11 is an exemplary diagram of a model connected to a haptic feedback system interacting with a physical model; and

FIG. 12 is an exemplary diagram of a model connected to a haptic feedback system interacting with a virtual model.

### DETAILED DESCRIPTION

Modeling systems are used to represent, simulate, and predict the reaction of various structures within and between themselves, and generally include the coupling together of a plurality of structural elements. Such structural elements can include nodes and bonds. Bonds are commonly used to couple nodes together, and these can be used to represent, for example, molecular and atomic particles and interactions. However, similar structural modeling elements are used in many technological fields, including buildings, bridges, trusses, foundations, and many other civil structures. The invention is useful in these fields, as well as in the field of atomic and molecular modeling, and others. The invention encompasses both physical and computer-based (virtual) modeling systems. For clarity and ease of description, the following discussion and explanations focus primarily on molecular modeling technology. However, the invention has application to many other, additional, fields of endeavor.

The figures and descriptions of the present invention have been simplified to illustrate elements that are relevant for a clear understanding of the present invention while eliminating, for purposes of clarity, other elements. For example, certain system architecture details, such as certain details of the hardware and software characteristics, are not described herein. Those of ordinary skill in the art will recognize, however, that these and other elements may be desirable in a typical modeling kit, model, software system, or communications network. A discussion of such elements is not provided because such elements are known in the art and because they do not facilitate a better understanding of the present invention. Modeling systems are used to represent, simulate, and predict the reaction of various structures within and between themselves, and generally include the coupling together of a plurality of structural elements. Such structural elements can include nodes and bonds. Bonds are commonly used to couple nodes together, and these can be used to represent, for example, molecular and atomic particles and interactions. However, similar structural modeling elements are used in many technological fields, including buildings, bridges, trusses, foundations, and many other civil structures. The invention is useful in these fields, as well as in the field of atomic and molecular modeling, and others.

The invention encompasses both physical and computer-based (virtual) modeling systems. For clarity and ease of description, the following discussion and explanations focus primarily on molecular modeling technology. However, the invention has application to many other, additional, fields of endeavor.

The figures and descriptions of the present invention have been simplified to illustrate elements that are relevant for a clear understanding of the present invention while eliminating, for purposes of clarity, other elements. For example, certain system architecture details, such as certain details of the hardware and software characteristics, are not described herein. Those of ordinary skill in the art will recognize, however, that these and other elements may be desirable in a typical modeling kit, model, software system, or communications network. A discussion of such elements is not provided because such elements are known in the art and because they do not facilitate a better understanding of the present invention.

The present invention concerns the interaction between two or more models, one or more of those models being a physical model of a structure or system that is interfaced with a software system on a computation device. A model of interest interacting with a physical model may be a virtual model generated in a software system on a computational device. A structure or system of interest may be a molecule, a set of molecules, a particular area of a molecule or sets of molecules, or an individual atomic element.

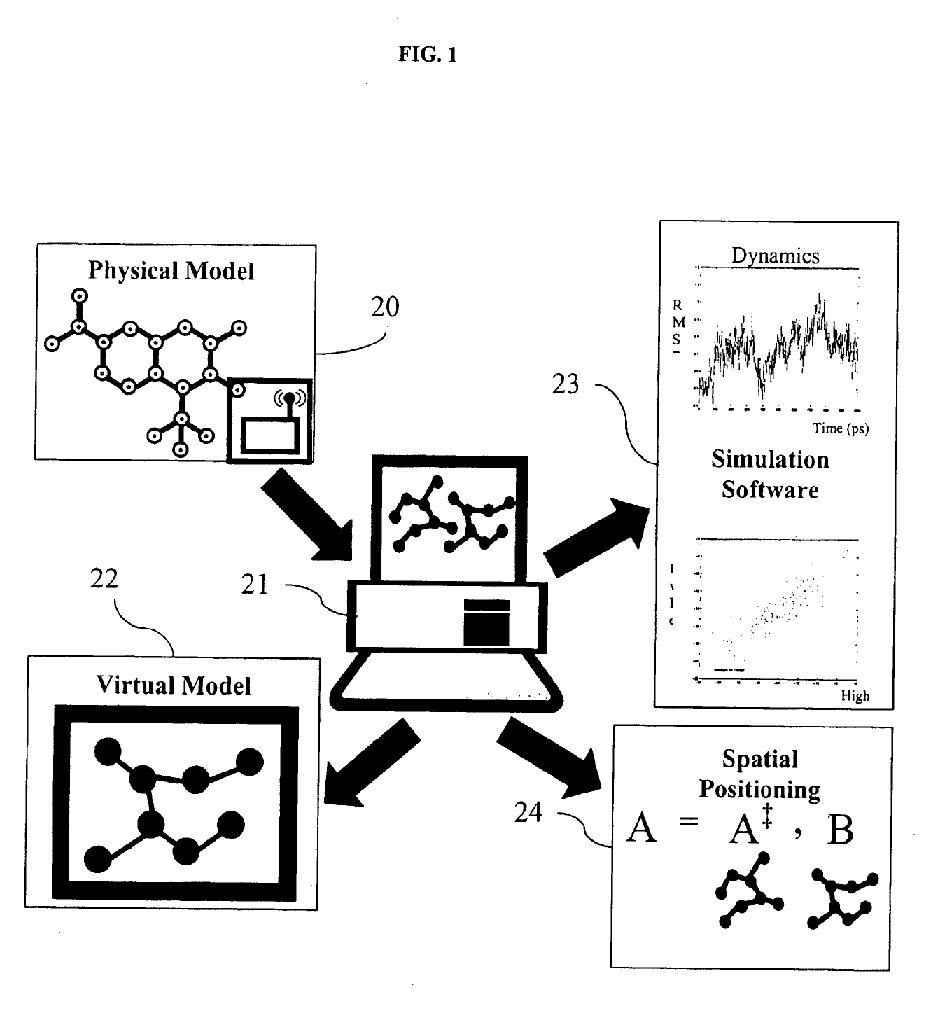

FIG. 1 is an exemplary diagram of an interactive modeling system that includes a physical model and a virtual model, and a system for assembling, visualizing and simulating molecular interactions between the two. The invention overcomes the limitations of the prior art by interconnecting a physical three-dimensional molecular model 20, with a virtual model 22, through a computational device 21, such as a computer with a display screen, running a molecular simulation software system 23 and a spatial positioning system 24. In other implementations the second model is a second physical model. A communications interface between the physical model 20 and computational device 21 may be wired or wireless. The simulation software system 23 is capable of representing characteristics of a particular molecule or molecules and the spatial positioning system 24 is capable of calculating the changing characteristics of such molecules as they are subject to changing environments or changing molecular structures. These two software tools can communicate and update each other, or can be integrated into one software tool. Such calculations can be communicated to the physical model 20 so that it can update its physical characteristics by means of internal mechanisms or a haptic arm, both of which are outlined below and not visible in this figure.

In particular, the invention of FIG. 1 is capable of calculating the interaction between two molecular models based on relative distance of the models, the configuration of those models, and other factors. This invention can update the energy characteristics of the molecular system as the physical model is modified physically or as the virtual system is modified through the software system. Calculated variables can include Van der Waals energies, internal conformational energies (such as bonds angles, and dihedrals), screened Coulombic energies, solvation energies, and the like. Thus, the physical model and any virtual models can be represented in a computer-based software tool where complex calculations can be performed to determine, e.g., high-level quantum mechanical calculations, molecular dynamics, and many other types of physical characteristics. Various rendering and movie making capabilities can also be included in the software running on the computer 21.

The interactive modeling system of FIG. 1 supports the further embodiments and applications of the invention explained in more detail below. A docking system incorporates the characteristics of a physical model and other models, computational characteristics from a software simulation system, and the relative positioning of molecular models. In some implementations of the invention, a haptic system allows for feedback of changes in the above characteristics.

Reference will now be made in detail to several illustrative embodiments of the present invention, examples of which are shown in the accompanying drawings. Wherever possible, the same reference numbers will be used throughout the drawings to refer to the same or like parts.

Physical Molecular Model

In using the invention in the field of molecular modeling, a model can be an atomic level description or representation of a molecule of interest or a molecular component of interest. Elements of the molecular model may be able to move with respect with other elements of the model. Such movement may be controlled through passive mechanisms such as springs, through active mechanisms such as actuators, or a combination of such. Such functionality is described by the same inventors in U.S. patent application Ser. No. 10/750,521, filed on Dec. 31, 2003, entitled Apparatus and Method for Integrating a Physical Molecular Model with a Computer-based Visualization and Simulation Model. In addition, this present invention overcomes the prior art by enabling the position of each atomic unit in the molecular system, or a set of atomic units, to be monitored or determined by a positioning system, introduced below. Molecules of any type may be modeled, including but not limited to, proteins, nucleic acids, carbohydrates, organic molecules and inorganic molecules.

The type and degree of molecular mobility may vary between the various model systems of choice. For example, the physical model for a protein may include flexibility and conformational sensing at key regions of known mobility (or regions of particular interest to the user), while regions of rigid secondary or tertiary structure (or regions that are not of particular interest to the user) may be held fixed. In a different implementation, the physical model may be of only one active section of the molecule, with the full system possibly represented in the virtual model. Degrees of freedom for such a system may include, but are not limited to, hinging motion between two alpha helices, loop mobility, or super-coiled alpha helix movements. A flexible organic drug molecule, on the other hand, may include flexibility and conformational sensing for the majority of the rotatable bonds in the molecule as well as bond angle and bond lengths. In practice, all internal degrees of freedom may be simultaneously monitored for any molecular system. This includes bond lengths, bond angles, and dihedral angles.

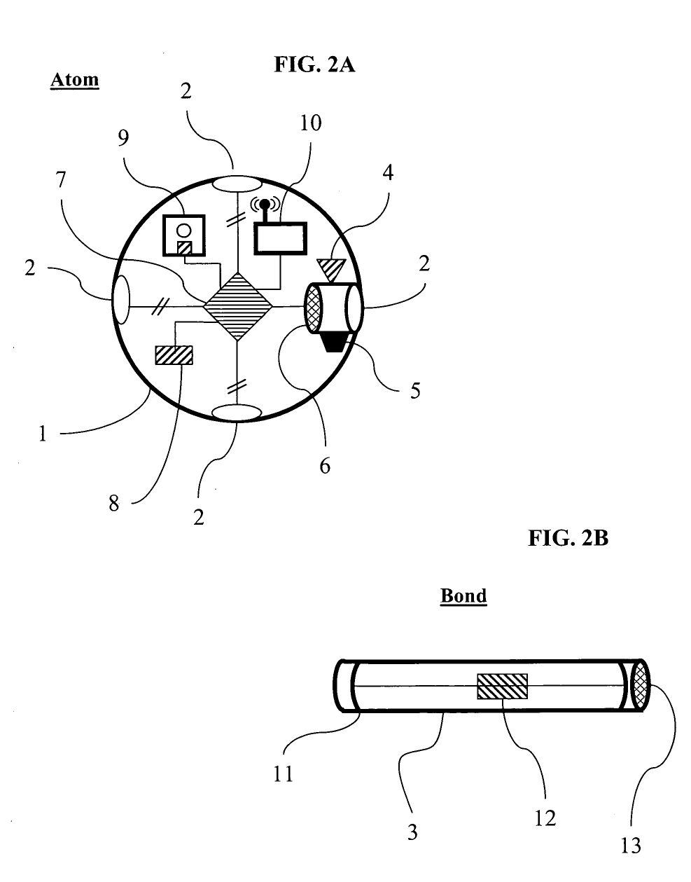

FIG. 2 illustrates some elements that may be present in or on the atomic units, the atom 1 and bond 3, of a physical model. Such elements may be networked internally to each other and to mechanical components, such as an internal simulation software system 9 or an internal computational device 7, to enable some level of internal communication. Further, a transmission unit 10 can provide communication with other atomic units, other physical models, an external computational device or simulation software system, or other external devices.

The atom 1 has connection ports 2 that allow physical interconnection between the atom 1 and bonds 3, and indirectly allows a communications interface with other atoms and bonds. The atomic units may contain one or more internal positioning units 6, which may include a sensor 4 an actuator 5, or other elements such as an accelerometer. An atomic unit may contain a surface mounted positioning unit, not pictured here, such as a beacon or some other active or passive device that can be utilized by an external positioning system or other atomic units to determine relative positioning of the atomic unit.

The physical model may contain one or more embedded or surface-mounted visual, tactile, or audible (or other human interface) signaling units 20, which may take the form of single or multi-color light emitting diodes (LEDs), textual or graphical displays, vibrational motors, or other devices. The signaling unit 20 may also display information passed to the physical model from the simulation software system or some other system or device such as a data structure, input device or other physical model. Examples of such information are the energetic contribution of an atom or group of atoms to the currently modeled state, the detection of steric clashes between a ligand and receptor, and environmental factors such as temperature or electromagnetic fields. The display of such information on the model itself, as well as within the simulation software system containing the virtual model, enhances the usability of the device.

Spatial Positioning System

The invention includes a positioning system, introduced in FIG. 1, which is a mechanism or means for detecting the relative position of two or more molecular models, at least one being a physical model. As a physical model exists in or is moved through space, its relative position to one or more other models can be detected by such positioning system. One or more of the molecular models may be a virtual model on a simulation software program.

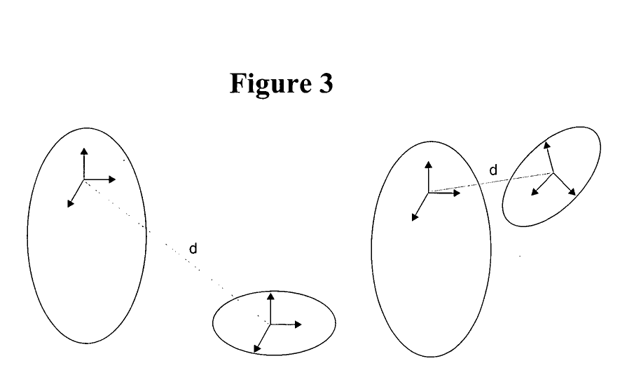

There a various ways in which the position of a molecular model can be determined. FIG. 3 is a conceptual representation of how positional and orientational sensors may be used to determine relative positioning of two molecules. The positioning system, using sensors on each model or by detecting the physical elements of the model itself, define a reference frame of an individual model. The distance “d” between a set of reference frames and their relative orientation, defines the positioning of the two models. This is a representation for conceptualization only, and no mechanism or type of sensor is implied by this FIG. 3. The sensors on each model, or the physical elements of the model itself, define a coordinate system. The distance “d” between the two origins and the relative rotation of the two coordinate frames combine to uniquely determine the orientation of the molecules.

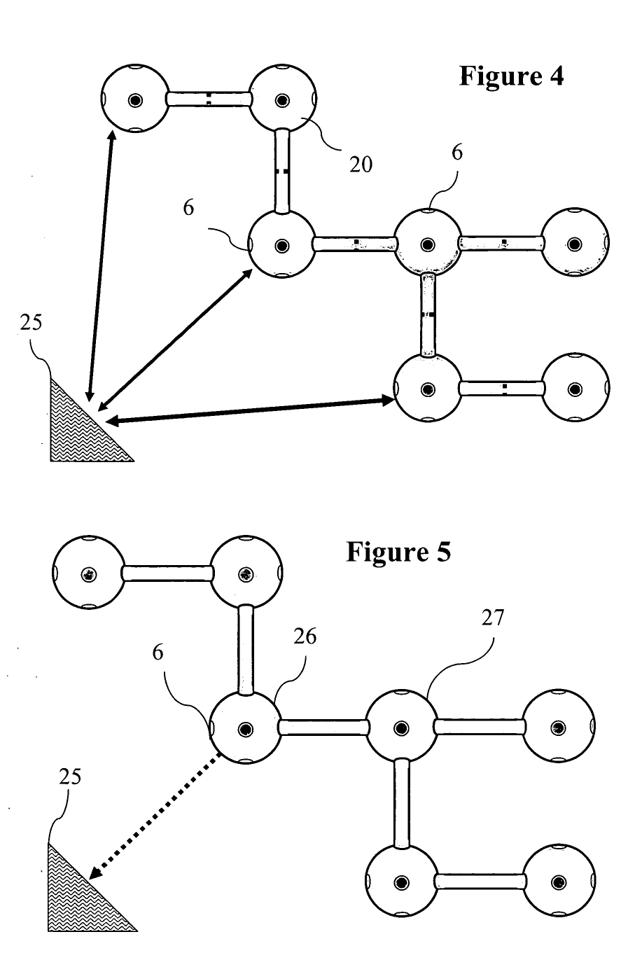

In a possible implementation illustrated in FIG. 4, a physical model 20 contains one or more positioning units 6, such as sensors or beacons, for determination of the relative positioning and orientation of the individual atomic units, or the full physical model in space, by means of a detection unit 25. Such detection unit 25 may be in communication with the physical model 20, a simulation software system, other physical models, or a combination thereof. In FIG. 5 a more simplified model has a subset of the atomic units 26 of a physical model networked to other atomic units 27, that subset containing one or more positioning units 6 that can be detected by a detection unit 25. A positioning unit 6 may be of any type that provides positional and/or orientational information or assists in providing such. These include, but are not limited to, systems based on gyroscopic, inertial, optical, sonar, or radio devices.

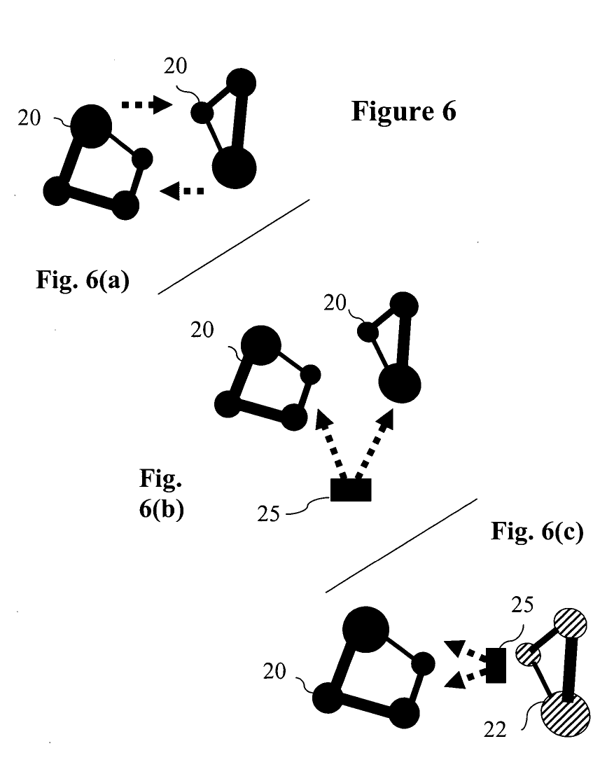

FIG. 6(a)-(b) illustrate some of the possible means of determining relative position between multiple models. In 6(a) two physical models 20 interact by means of their internal positioning systems. This interaction may be direct to each atomic unit or to a subset of atomic units. In some implementations the computational capabilities of individual atomic units may independently determine the relative position of the physical models. The interaction may be indirect, with the atomic units communicating with an internal or external simulation software system to determine the relative position of the physical models.

The positioning system need not be internal to the physical model. In 6(b) an external detection unit 25 senses the relative position of two physical models. In FIG. 6(c), an external detection unit 25 is used to detect the position of a physical model 20. In this implementation the simulation software superimposes in virtual space a virtual model 22. The relative position between the physical model 20 and the virtual model 22 is mapped by the simulation software system, which is in communication with the detection unit 25 or the virtual model 22, or both. This superposition can be displayed visually on a display device or portrayed in space next to the physical model. The external detection unit 25 may utilize sensors, which may include, but are not limited to, cameras, lasers, global positioning systems (GPS), or other devices to detect the position of physical objects. These sensors may be part of an integrated detection system or placed independently, and may be used in concert with positioning units within the physical model.

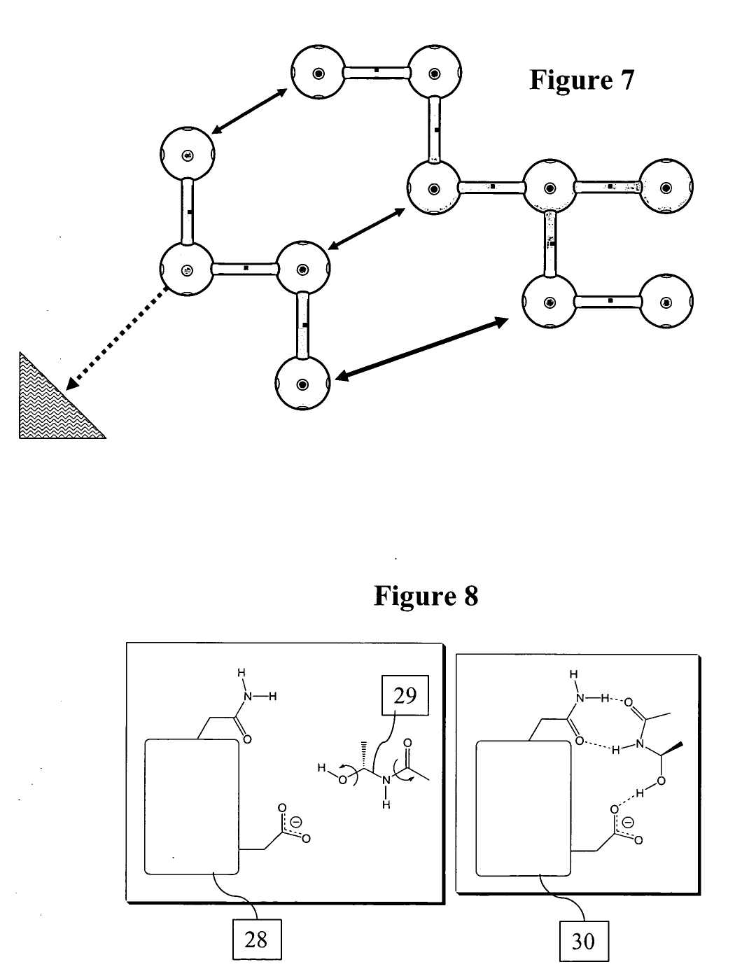

In a further implementation, the positioning system may provide a means of communicating accumulated positional information and other data of a physical model to the simulation software system or other physical models, and feedback data from such simulation software system. The communication may also be between two or more physical models, with or without direct interface with the simulation software system. One implementation is FIG. 7, in which relative positioning can be determined from atomic units of one physical model communicating with atomic units of another physical model. The resulting information can be transmitted back to the computational device running the simulation software through one or more atomic units which has a communications interface with the computational device. The above implementations will allow direct interaction for real-time response of intermolecular factors, such as attraction or repulsion.

Computer Interface between the Physical Model and Virtual Model

The state of one or more positioning units in the physical model is transmitted through a wired or wireless interface to a simulation software system. The simulation software may transmit data computed within the software system, or other computational systems, to the physical model through the same or similar communication interface to control the orientation of the physical model through the use of actuators within the physical model or a haptic arm. Such simulation software can provide information for visual or audible (or other human interface) signaling units embedded in the model. Data can be transmitted between physical models, or between a model and one or more external sensor units.

The physical model may be represented as a virtual physical model in a simulation software program. The virtual physical model may consist of a complete or partial representation of all properties embodied by the actual physical model. In addition, the virtual physical model may include additional components not present in the physical model. An example of this is a physical model of a pharmaceutical candidate molecule coupled with an additional virtual model of the target receptor for the molecule. An alternative example is a physical model of a single component of an extended system such as a crystal. Analyses of the simulated physical model or models may be done within the context of the software simulation system and provided as feedback data to the physical model, allowing physical manipulation of a region of interest. Relevant properties may be evaluated by the simulation software system on the physical model itself.

Simulation Software System and Virtual Model

The simulation software system contains a description of all the properties, or those properties of interest, embodied by the state of the physical model. Such properties can be used to construct a virtual physical model of the physical model in the simulation software system. Internal geometries of molecular components may be generated from the state of the positioning units of the physical molecular model. Relative positions of the molecular components may also be generated from the state of the positional units, or from the positioning system.

A virtual model can also be constructed within or through the simulation software system without a corresponding physical mode. The user can input, or the simulation software system can generate, the necessary or appropriate properties of the desired molecular system. Internal geometries and relative positions of the molecular components may be assigned or generated. A virtual model can also be positioned in a virtual environment, containing other virtual models or virtual physical models or other elements that may impact its nature. The virtual model can also be assigned a position relative to a sensing device or detection unit.

The simulation software system has the capability for computation of molecular properties using a range of methods at numerous levels of theoretical detail and complexity. In addition, simulation of the system using a number of methods, including energetic minimization, dynamic simulation and conformational search, are possible.

Details of the simulation software system and the virtual model may be output to a display device, to attached storage, to the physical model, or to additional software or hardware systems and networks. Input to the simulation software system and virtual model is similarly not limited to the physical model input device. Structural, energetic and other data may be read from computer storage, from additional software or hardware systems and networks, or user input devices.

The simulation software system and virtual model may also be used to guide the user's manipulation of the physical model to a target structure contained in the software system or a contained in a neighboring physical model. As the user manipulates the physical model in translational, rotational, and internal degrees of freedom, the simulation software system displays regions of high and low similarity between the physical model and the target virtual model using visual cues displayed on a computer display. Similarly, other visual, tactile, or audible (or other human interface) signaling can guide the user in the relative positioning of two or more physical models.

Molecular Docking System

The above description and figures establish the fundamental elements to realize a docking system that determines, detects, guides, and realizes the docking of two or more molecular models. Molecular docking is the process by which molecules recognize and interact with one another. This includes the process of molecules binding to one another, and the opposite process of two or more elements of a system unbinding and becoming independent molecular systems. With the growing sophistication of computational tools, molecular docking extends to the prediction of, for example, a ligand-receptor structure from the conformation of an unbound ligand and an unbound receptor. The present invention enables this otherwise computational exercise on a computer, or laboratory exercise in a test tube, to become an intuitive three-dimensional experience with both computational accuracy and physical human interaction. Molecular docking is an increasingly important area of research in protein engineering and drug design.

FIG. 8 demonstrates one implementation of the invention that allows for the sampling of numerous degrees of freedom in molecular docking. In order to dock the molecule 30 and idealized receptor 31 into the optimal orientation 33, the molecule may be translated, rotated, and several of the internal degrees of freedom may be varied to realize docking. It is also possible for the internal degrees of freedom on the receptor or any of the molecules in the system to vary during the docking process, or after as environmental conditions change. The particular representation of this figure may be two physical models of the molecule and receptor or one physical model and one virtual model.

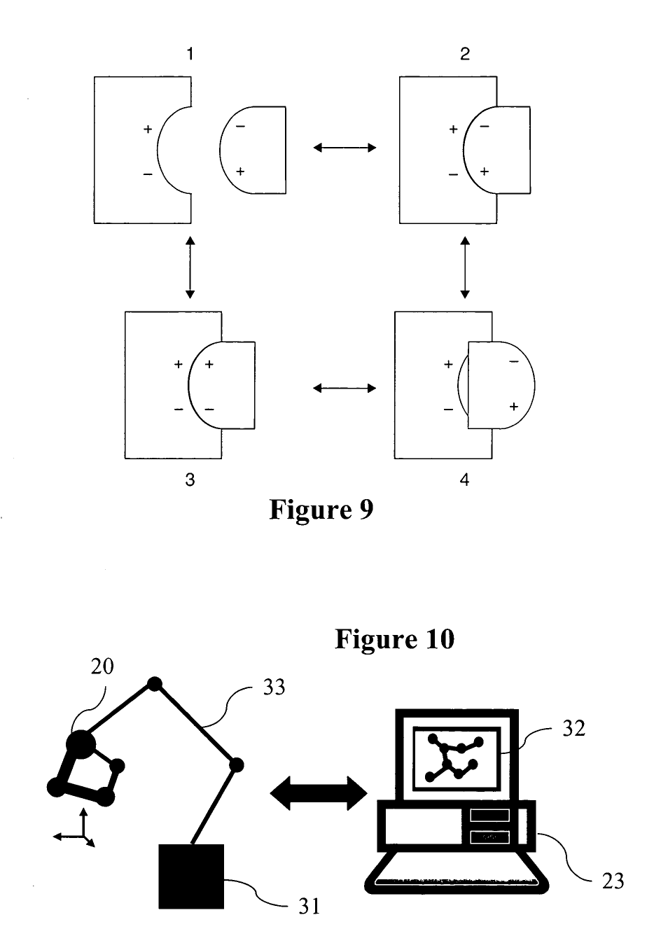

FIG. 9 illustrates the positional and orientational dependence on the energetics of docking in a molecular system. FIG. 9.1 is weak favorable electrostatic interactions and weak favorable steric interactions. FIG. 9.2 is strong favorable electrostatic and strong favorable steric interactions. FIG. 9.3 is strong unfavorable electrostatic interactions and strong favorable steric interactions. FIG. 9.4 is favorable electrostatic interactions and strong unfavorable steric interactions. The orientation of FIG. 9.2 is preferred, absent other environmental variable that may be introduced into the system. There are numerous physical quantities and characteristics in addition to electrostatics that may be used to calculate the energetic state of a system. Any or all of these quantities may be used to provide feedback data to the system.

Haptic Feedback System

A further improvement to the current invention incorporates a haptic feedback system interfaced with a simulation software system or interfaced directly to a physical model for molecular modeling, docking, and simulation through a bi-directional interface.

Haptic feedback is desirable in many molecular modeling applications. Applications may be, but are not limited to, internal motions within a single molecule governed by molecular forces and properties; forces exerted on a molecule as a result of applied external forces, such as an electric field or variable dielectric constant; interactions between two or more physical models, such as in molecular docking; interactions between a physical model and two or more virtual models, such as in docking or interactions of a molecule with a surface; or interaction of one or more physical models interacting with one or more virtual models, such as proteins interacting on a cell surface.

Such haptic feedback may be in coordination with a simulation software system on a computation device capable of communicating, wirelessly or wired, with such haptic feedback system directly or indirectly through one or more physical models. Such computational device may be a multi-use computer, a standard desktop PC, a hand-held device, a commercial workstation, or a multiple user server. The simulation software system, or a subset of that system, may itself be embedded within the physical model or other associated device, such as a position system.

FIG. 10 represents one implementation of a haptic feedback system, in which one or more molecular components of the physical model 20 are linked to a haptic arm 30. The feedback arm is connected to a control device 31 which is in communication, wired or wirelessly, with the simulation software system. The haptic arm 30 can act as an energy source as well as a data transmission mechanism for the physical model 20. In this case, the user holding the physical model 20 will feel forces from the haptic arm 30 (depicted by the three arrows, for simplicity) resulting from calculations being performed by the simulation software system 23. Similarly, movement on the haptic arm 30 can be communicated to the software simulation system 23, and information as well as a virtual model can be displayed on a display device 32. This shows one implementation of how a physical model can communicate its state to a simulation software system, such that the simulation software system can perform calculations on various environmental factors and provide feedback to the physical model or to a molecular system represented on a display device.

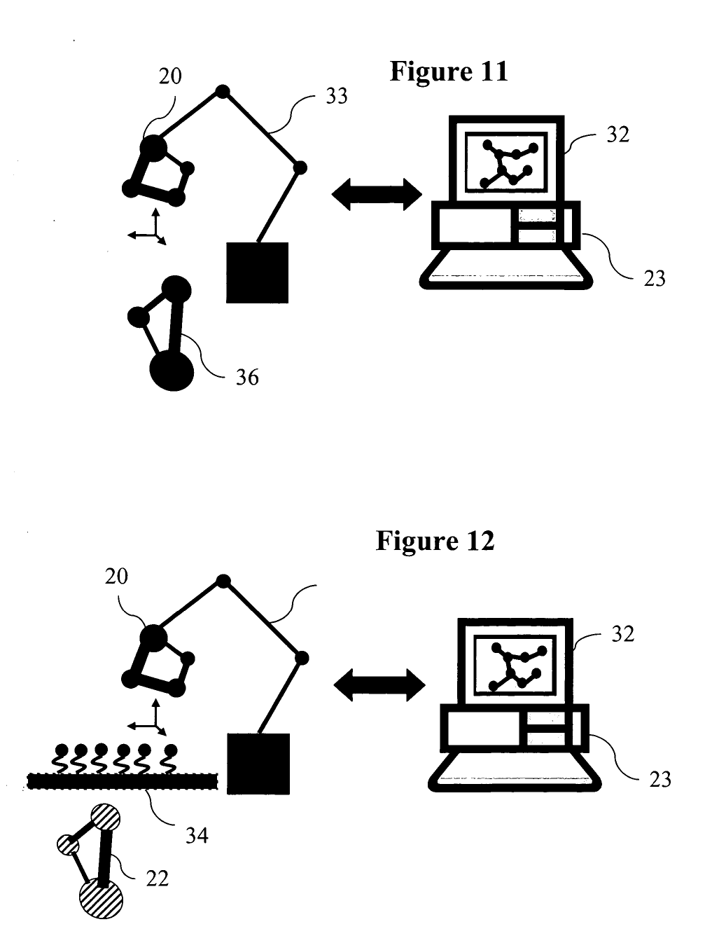

Feedback can be a result of a physical model's interaction with one or more physical models. In FIG. 11 a physical model 20 on the haptic arm 30 produces forces on the user's hand as a result of the interactions with the second physical model 33. Such interactions can be based on the docking or positioning systems introduced above, or in coordination with a general haptic feedback system as introduced in FIG. 10.

Feedback can be a result of one or more physical models interaction with one or more virtual models. In FIG. 12, a physical model 20 on the haptic arm 30 produces forces on the the user's hand as a result of the interactions with a particular point in space, here demonstrated as a sensor plate 34 which could be part of a positioning system or a detection unit. A simulation software system may superimpose a virtual model on the particular point or points in space. While movement by the physical model may result in force feedback, virtual movement or changes to the virtual model introduced by the simulation software system can also result in feedback. Such movement may also influence the virtual model's position in virtual space within the simulation software system and on a display device.

Through the external haptic feedback system, translational and rotational movements of each molecular component in the physical model are mechanized. The resistance strength and other feedback properties are determined by the characteristics of interest (such as the energy of the system) as computed within the simulation software, provided from other devices, or based on user input. The physical model or a subset of atomic units within a physical model may also contain an independent feedback mechanism similarly in communication with a simulation software system, the haptic feedback system, or with other devices. The physical model movement can be accomplished by the haptic arm, or by the mechanics of the atomic units outlined in FIG. 2, or by a mix of both. Certain regions of the molecule may be rigidly constrained to a given geometry, while other regions may be controlled by actuators or other means.

The model may also contain a system for handling additional feedback information from other sources, real time or time-delayed data, to the physical model or back to the simulation software system or other devices. The simulation software system can also receive input from sources other than the physical model. These may include structural and energetic data from computer storage, interfaces with other software systems, and interfaces with databases of chemical data. This and other data may be displayed using visual or audio signaling units, such as single or multi-color light emitting diodes (LEDs), or with tactile features such as vibrating units within some or all atoms, embedded within the model.

In the case of haptic feedback control by the simulation software, any of a variety of quantities may dictate the nature of the feedback. For example, the feedback resulting from two interacting ions may be governed primarily by electrostatic energies calculated within the simulation software. These electrostatic energies can be calculated by any desired formula or method. In another case, the feedback resulting from two interacting hydrophobic molecules such as methane or octane may be governed primarily by van der Waals energies calculated within the simulation software. Again, these quantities can be calculated using any desire technique. Any combination of energetic or other molecular properties calculated within the computational software can be used to govern the nature of the haptic feedback.

In the case of haptic feedback control by embedded hardware, any set of devices on the physical model may control the nature of the feedback. One example is a simple set of springs embedded within the bonds to account for bond vibrations and will give feedback if the bonds are stretched or compressed too much. Similarly, springs or other devices may be used to for bond angles and dihedral angles and could be set manually or computationally to give feedback based on the desired characteristics. A more advanced case may be one in which hardware embedded within the physical model is programmed to behave in a certain fashion based on the desired molecular criterion.

Bi-directional Interface

The physical model and simulation software system are able to communicate with each other through a bidirectional interface, either wired or wireless. A description of the physical state of the molecule (conformation, orientation, and position) is passed from the physical model into the simulation software system via this interface. Such data may be used to generate the virtual model within the simulation software system and rendered on a display device. A description of the virtual status of the model (energetics, intermolecular forces, and any other value computable by the software) is passed from the simulation software system to the physical model via the same interface. Such data may be used to control the haptic feedback system in the model. In this manner, the physical state of the model, the resistance to motion generated by the feedback system, and the virtual state of the model within the simulation software, are all intimately connected.

Both the physical and virtual models can be operated independently of each other, such as when the user brings the physical model out of the range of the simulation software system or the transmission range of the overall system. When connected after such isolated operation, the state of either model may be updated so that the virtual and physical models are in agreement. In one case, the state of the physical model will be transmitted to the simulation software system and the virtual model will be updated based on the state of the physical model. This operation may be desired after the user assembles the physical model or alters its geometry while not connected to the computer. In the other case, the transmission interface will report the state of the virtual model in the simulation software system to the physical model and the orientation of the physical model will change based on the characteristics of the virtual model. This operation may be desired in a case when the virtual model had been modified, such as after a molecular dynamics simulation of energy minimization, while the physical model was either disconnected from the computer or in a frozen state. Either of the two above noted procedures for synchronizing the states of the physical and virtual model can be determined through the software interface or the simulation software system.

One embodiment of the invention is as a process of steps for realizing an interactive molecular docking system. The first step of this process can begin with the manipulation of a physical molecular model. Such tool allows the user to assemble a detailed atomic representation of a molecule or molecular system, and to observe how the structure changes due to the physical manipulation of the model. Such manipulation may be in space where the physical model moves relative to the position of a second model or the virtual position of a virtual model.

The next step is to assemble the data of the physical construction or manipulation of the physical model. This may be partly the step of determining the internal physical manipulation of the physical model under the user's control. This may also be partly the step of determining the change in space or position of the physical model relative to the position of a second model or the virtual position of a virtual model. Such data can be determined in all or in part from the positioning system internal to the physical model or the positioning system external to the physical model.

The next step is to transmit that data to a simulation software system. This may be thorough a wired or wireless transmission system, directly between the physical model and the simulation software system or via a positioning system or other device. The simulation software system in connection to a physical model, or a user independently, may take an additional step to construct a virtual model, and to allow the user to manipulate the virtual model in any number of ways. Such simulation software system and an associated virtual model allow for the computation of various properties of the molecular system, such as the conformational energetics, the energetics of interaction of two molecules, and the dynamic behavior of a system of molecules undergoing some transformation.

The simulation software system establishes the simulation environment, which generally includes all or a part of the virtual space in which the models will be or are already rendered, the configuration of any physical models or virtual models, and other environmental factors that the simulation software system or the user or some device may introduce into the system.

The next step is to transmit computational data from the simulation software system to the physical model. Such feedback may include audio or visual cues capable of additional audio or visual manipulation by the physical model. An additional step may be to have the simulation software communicate with a haptic feedback system for motion in multiple degrees of freedom (generally three translational degrees of freedom, three rotational degrees of freedom, and 3×N−6 internal degrees of freedom, where N equals the total number of atoms in the system) for a particular physical model or models.

The invention can be used in both the classroom and research laboratory environments. For example, high school students currently using static, unintelligent models can use the invention to learn about the dynamic characteristics of physical (e.g., molecular) structures. Commercial researchers can use the invention to gain meaningful insights into the complex relationships on the atomic level, and to represent such relationships in both physical and virtual formats.

It should be understood that the invention is not limited by the foregoing description, but embraces possible alterations, modifications, and variations. Those skilled in the particular art will recognize additional applications without departing from the scope or spirit of the invention. This may be for representative models of architectural structures, biological systems, or manufacturing facilities.

By the above it can be seen that a highly useful apparatus and methods have been developed for an interactive modeling device and system for physical and virtual models, whereby considerable time savings and efficiency improvements can be obtained. The terms and expressions employed herein are used as terms of description and not of limitation, and there is no intention, in the use of such terms and expressions, of excluding any equivalents of the features shown and described or portions thereof, but it is recognized that various modifications are possible within the scope of the invention claimed.

1. A model kit for use in modeling a system comprising:
one or more physical models;
a computational device capable of simulating a model system;
a communications interface between the physical model and the computational device;
a positioning system in communication with the computational device, the positioning system with a means for determining the position of a physical model.

2. The model kit of claim 1 wherein the system is a molecule.

3. The model kit of claim 1 further comprising one or more beacons connected to the physical model, the beacon capable of sending a signal to determine the position of the physical model.

4. The model kit of claim 1 further comprising a display device in communication with the computational device, the display device capable of displaying a representation of the physical model.

5. The model kit of claim 1 further comprising a signal unit in communication with the physical model, the signal unit capable of signaling a characteristic of the molecular model.

6. The model kit of claim 5 wherein the signal unit emits a visible or audible signal.

7. The model kit of claim 1 wherein the positioning system is part of the physical model.

8. The model kit of claim 7 wherein the positioning system includes a sensor capable of sensing its own movement.

9. The model kit of claim 8 wherein the sensor is an accelerometer.

10. The model kit of claim 1, further comprising a feedback system in communication with the computational device and in contact with the physical model, the feedback system capable of manipulating the physical characteristics of the physical model.

11. The model kit of claim 10 wherein the feedback system is in communication with the positioning system.

12. model kit of claim 10 wherein such feedback system is a haptic arm.

13. The model kit of claim 10 wherein such feedback system is an actuator.

14. The model kit of claim 10 wherein the feedback system emits a visible or audible signal.

15. A method of determining the position of a physical model comprising:
obtaining physical location information of a physical model from a positioning system;
obtaining virtual space information of a simulation environment from a simulation software system;
computing the virtual location of the physical model in the simulation environment from the location information and the virtual space information.

16. The method of claim 15 wherein the physical model represents a molecular system or structure.

17. The method of claim 15 further comprising:
generating a virtual physical model in the simulation environment that captures all or some of the features of the physical model;
displaying the virtual physical model on a display device.

18. The method of claim 17 further comprising updating the virtual location based on changes to the simulation environment.

19. A method of determining the relative position of two or more physical models comprising:
obtaining physical location information of the physical models from one or more positioning systems;
obtaining virtual space information of a simulation environment from a simulation software system;
computing the virtual location of the physical models in the simulation environment from the relative location information and the virtual space information.

20. The method of claim 19 wherein the physical models represents a molecular system.

21. The method of claim 19 further comprising:
generating a virtual physical model in the simulation environment that captures all or some of the features of the physical model;
displaying the virtual physical model on a display device.

22. The method of claim 19 further comprising:
determining the simulated interaction between physical models;
transmitting the simulated interaction information to a feedback system;
manipulating the second physical model through the feedback system based on the simulated interaction information.

23. The method of claim 22 further comprising updating the virtual physical location based on changes to the simulation environment.

24. A method of determining the relative position of a physical model relative to a virtual model comprising:
obtaining physical location information of the physical model from a positioning device;
generating location information of a virtual model in a simulation environment from a simulation software system;
computing the virtual physical location of the physical model relative to the virtual model in virtual space.

25. The method of claim 24 wherein the physical model and virtual models represent a molecule.

26. The method of claim 24 further comprising:
generating a virtual physical model in the simulation environment from the virtual location of the physical model;
displaying the virtual physical model and virtual model on a display device.

27. The method of claim 24 further comprising:
determining the simulated interaction between the physical model and the virtual model;
transmitting the simulated interaction information to a feedback system;
manipulating the second physical model through the feedback system based on the simulated impact information.

28. The method of claim 27 further comprising updating the virtual physical location based on changes to the simulation environment.
